(19) United States
(12) Patent Application Publication
(10) Pub. No.: US 2020/0041801 A1
(43) Pub. Date: Feb. 6, 2020

(54) INSERTION AND EXTRACTION STRUCTURE, EYEWEAR AND ELECTRONIC DEVICE

(71) Applicants: K-TRONICS (SUZHOU) TECHNOLOGY CO., LTD., Suzhou (CN); BOE TECHNOLOGY GROUP CO., LTD., Beijing (CN)

(72) Inventors: Yiping HU, Beijing (CN); Wei SHI, Beijing (CN); Ronghui LIN, Beijing (CN)

(21) Appl. No.: 16/437,543

(22) Filed: Jun. 11, 2019

(30) Foreign Application Priority Data
Aug. 1, 2018 (CN) 201821229364.7

(51) Int. Cl. G02B 27/01; G02C 11/00

(52) U.S. Cl. CPC G02B 27/0176; G02B 2027/0169; G02B 2027/0178; G02C 11/10

(57) ABSTRACT

An insertion and extraction structure, an eyewear and an electronic device are provided. The insertion and extraction structure includes a main machine assembly and a support assembly, the support assembly includes a fixing member, the main machine assembly includes a first connector, the fixing member includes a second connector, and the main machine assembly is configured to be inserted into or extracted from the fixing member by cooperation between the first connector and the second connector; the first connector includes a first limiter portion, the fixing member includes a second limiter portion, and the first limiter portion is configured to cooperate with the second limiter portion so that the main machine assembly and the fixing member are positionally limited and are fixed in a situation where the main machine assembly is fixed by being inserted into the fixing member.

This application claims the benefit of Chinese patent application No. 201821229364.7 filed on Aug. 1, 2018, which is hereby entirely incorporated by reference as a part of the present application.

### TECHNICAL FIELD

Embodiments of the present disclosure relate to an insertion and extraction structure, an eyewear and an electronic device.

### BACKGROUND

Augmented reality technology integrates real world information and virtual world information “seamlessly”, and allows physical information (visual information, sound, taste, tactile information, etc.) that is difficult to experience in a certain tune and space of the real world to be simulated and then be superimposed with each other by science and technology such as a computer, so that the virtual information is used to the real world and is perceived by human senses, thus achieving a sensory experience that transcends reality. The augmented reality technology not only displays the real world information, but also displays the virtual information at the same time. These two kinds of information complement each other and superimpose each other.

In visual augmented reality, users use virtual reality glasses type displays to multiply fuse the real world and computer pictures. In the design process of virtual reality glasses, an optomechanical component is connected with an end of the glasses, and some structures is needed to realize the connection in the process of connection.

### SUMMARY

Embodiments of the present disclosure provide an insertion and extraction structure, an eyewear and an electronic device, to enable insertion and extraction between a main machine assembly and a support assembly, and to fix the main machine assembly and the support assembly together in case of insertion.

According to a first aspect of the embodiments of the present disclosure, an insertion and extraction structure is provided, the insertion and extraction structure includes a main machine assembly and a support assembly, the support assembly includes a fixing member, the main machine assembly includes a first connector, the fixing member includes a second connector, and the main machine assembly is configured to be inserted into or be extracted from the fixing member by cooperation of the first connector and the second connector; the first connector includes a first limiter portion, the fixing member includes a second limiter portion, the first limiter portion is configured to cooperate with the second limiter portion to achieve that the main machine assembly and the fixing member are positionally limited and are fixed in a situation where the main machine assembly is fixed by being inserted into the fixing member.

For example, a first surface of the first connector is attached to a second surface of the second connector.

For example, the second connector is a rotator block, and the fixing member further includes a rotating fixing member and a stir mechanism; the support assembly is provided with a first recess configured for accommodating the rotator block, and the first recess is provided with a first through hole; the rotator block is provided with a second recess configured for accommodating the main machine assembly, and the second recess is provided with a second through hole; the rotating fixing member includes a first end, a hollow portion and a second end which are sequentially connected, the first end is in the second recess and is provided with a third through hole, the hollow portion is between the first through hole and the second through hole, the hollow portion has a cavity and communicates with the third through hole, and the second end is configured to be on a side of the support assembly away from the first recess in the situation where the main machine assembly is fixed by being inserted into the fixing member; a size of an outer edge of the first end is larger than a diameter of the second through hole; the stir mechanism is in the hollow portion, an end of the stir mechanism is provided with the second limiter portion, the second limiter portion is configured to penetrate the third through hole, and the second limiter portion is configured to enter the third through hole under an action of an external force or is configured to bounce from the third through hole.

For example, the second end includes a recessed step structure; the fixing member further includes a fastener structure; the fastener structure is configured to be assembled with the recessed step structure to avoid the recessed step structure from passing through the first through hole and to allow the fixing member to rotate relative to the support assembly under the action of the external force in the situation where the main machine assembly is fixed by being inserted into the fixing member.

For example, the second limiter portion includes a top bead, and the first limiter portion includes a first groove configured for accommodating the top bead; the first groove is at the first surface.

For example, the second limiter portion includes a top bead, and the first limiter portion includes a first groove configured for accommodating the top bead; the first groove is at a surface which is included by the first connector and faces the second connector.

For example, the stir mechanism includes the top bead, a spring and a screw; a first end of the top bead is connected with a first end of the spring, and a second end of the top bead is configured to pass through the third through hole and then connect the second limiter portion; the top bead is configured to enter the third through hole along a direction from the top bead to the screw under the external force or is configured to bounce from the third through hole along a direction from the screw to the top bead under an action of the spring; the screw is provided with a second groove at a position where the screw contacts a second end of the spring, and the second end of the spring is in the second groove; the hollow portion includes an internal thread that is configured to cooperate with an external thread of the screw, and the screw is configured to fix the spring and the top bead in the hollow portion.

For example, the first limiter portion further includes a first fastener, and the second limiter portion further includes a second fastener that is configured to cooperate with the first fastener.

For example, the first fastener of the first limiter portion is at a lateral surface of the first connector, and the lateral surface intersects the surface which is comprised by the first connector and faces the second connector.

For example, one of the first fastener and the second fastener is a protruding fastening point and the other of the first fastener and the second fastener is a fastening groove configured for accommodating the fastening point; or, one of the first fastener and the second fastener is a sliding groove and the other of the first fastener and the second fastener is a sliding rail that is configured to cooperate with the sliding groove.

For example, the second limiter portion includes a protruding fastening point, the second connector is provided with the protruding fastening point, and the first limiter portion includes a fastening groove configured for receiving the fastening point; or, the first limiter portion includes a protruding fastening point, and the second limiter portion includes a fastening groove configured for receiving the fastening point, and the second connector is provided with the fastening groove.

For example, the first limiter portion includes a sliding groove, and the second limiter portion includes a sliding rail that is configured to cooperate with the sliding groove; or the first limiter portion includes the sliding rail, and the second limiter portion includes the sliding groove that is configured to cooperate with the slide rail.

According to a second aspect of the embodiments of the present disclosure, an eyewear is provided, and the eyewear includes an eyewear leg, an optomechanical assembly and the insertion and extraction structure according to any one of the above embodiments; the eyewear leg is connected with the support assembly, and the optomechanical assembly is connected with the main machine assembly.

According to a third aspect of the embodiments of the present disclosure, an electronic device is provided, and the electronic device includes the insertion and extraction structure according to any one of the above embodiments.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a schematic structural view of an insertion and extraction structure provided by at least one embodiment of the present disclosure;

FIG. 2 is a schematic view of parts of the insertion and extraction structure provided by at least one embodiment of the present disclosure;

FIG. 3 is a partial sectional view showing the parts of the insertion and extraction structure provided by at least one embodiment of the present disclosure;

FIG. 4A is a schematic view of a rotating fixing member in the insertion and extraction structure provided by at least one embodiment of the present disclosure;

FIG. 4B is a schematic side view of a rotator block in the insertion and extraction structure provided by at least one embodiment of the present disclosure;

FIG. 4C is a schematic sectional view of the rotator block in the insertion and extraction structure provided by at least one embodiment of the present disclosure;

FIG. 4D is a schematic sectional view of a body of a support assembly in the insertion and extraction structure provided by at least one embodiment of the present disclosure;

FIG. 5 is a sectional view of the insertion and extraction structure provided by at least one embodiment of the present disclosure;

FIG. 6 is a sectional view of a location A of the insertion and extraction structure in FIG. 5, provided by at least one embodiment of the present disclosure;

FIG. 7 is a schematic view illustrating a fastener limit for the insertion and extraction structure provided by at least one embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

An insertion and extraction structure, an eyewear and an electronic device provided by the present disclosure are described in detail below by illustrating several specific embodiments.

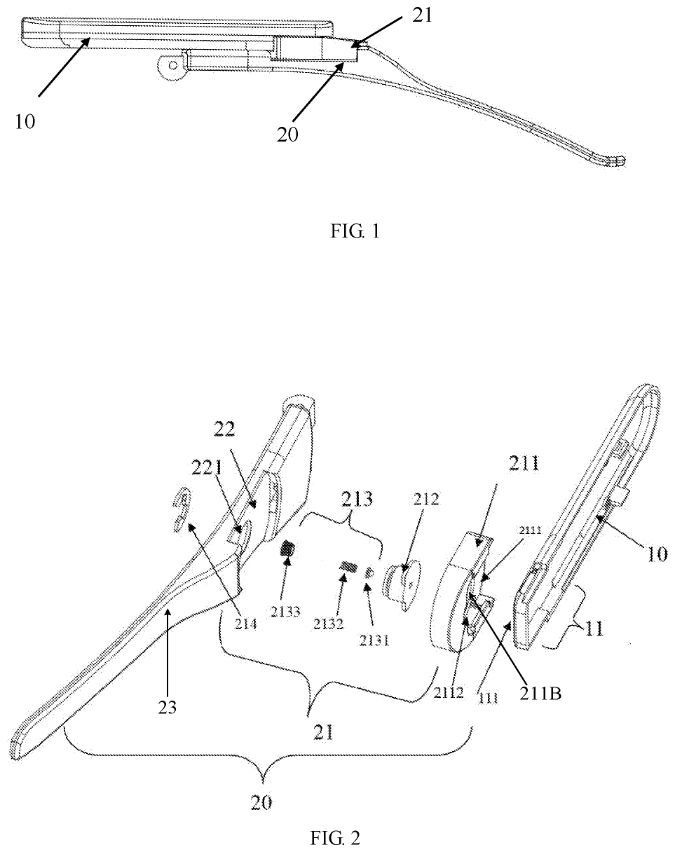

Referring to FIG. 1 and FIG. 2, a schematic structural view of the insertion and extraction structure according to the embodiments of the present disclosure is shown. The insertion and extraction structure includes a main machine assembly 10 and a support assembly 20, and the support assembly includes a fixing member 21. For example, the main machine assembly 10 is any type of electronic component such as a display or any type of non-electronic component. For example, the support assembly 20 is any type of support such as an eyewear leg of an eyewear or a wrist strap of a watch. The embodiments of the present disclosure do not limit the types of the main machine assembly 10 and the support assembly 20.

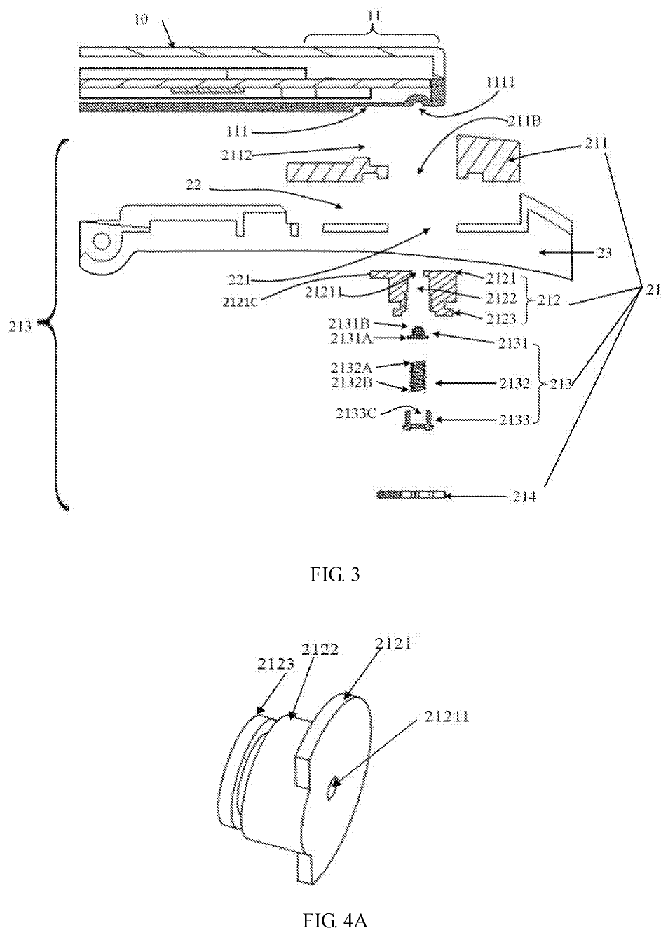

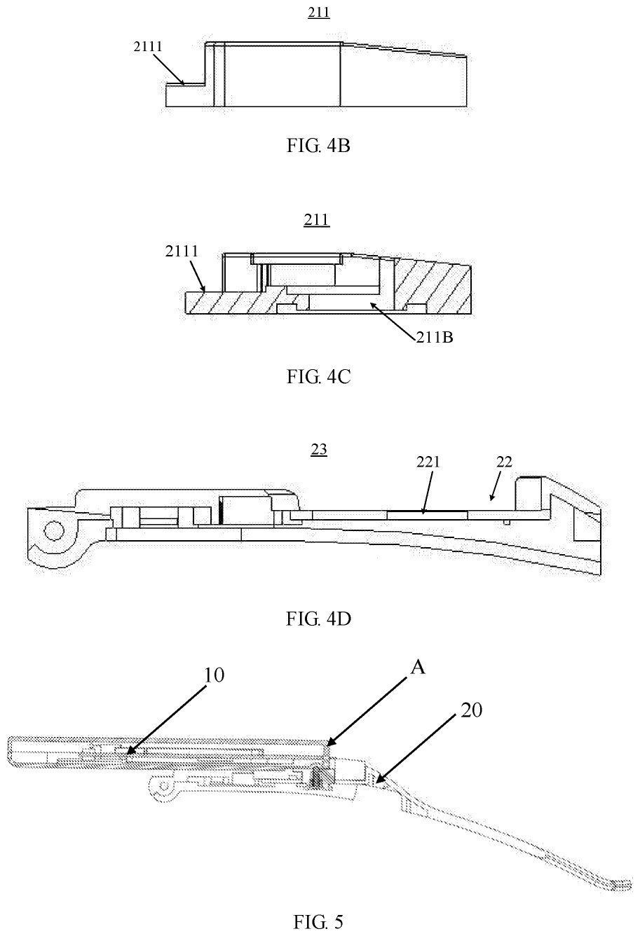

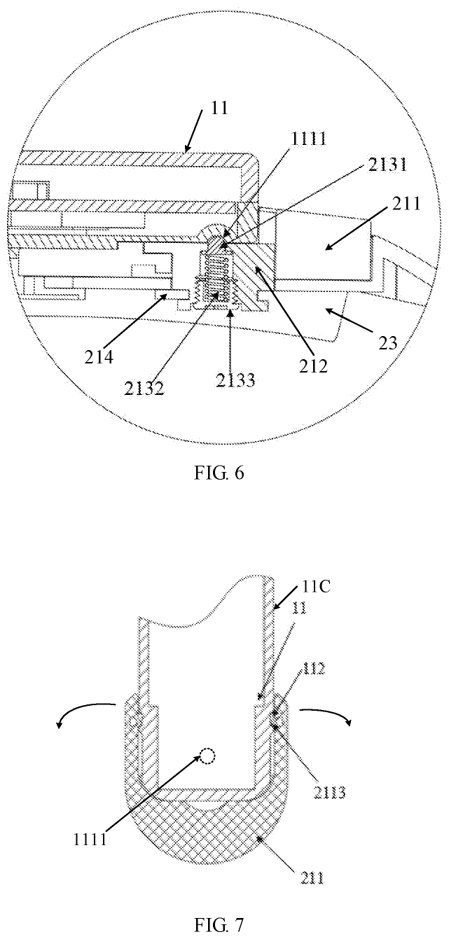

Referring to FIG. 2 to FIG. 7, the main machine assembly 10 is provided with a first connector 11, the fixing member 21 is provided with a second connector 211, and the main machine assembly 10 is configured to be inserted into or be extracted from the fixing member 21 through cooperation of the first connector 11 and the second connector 211. The first connector 11 has a first limiter portion; for example, the first limiter portion includes a first groove 1111 as shown in FIGS. 3 and 6 and/or includes a first fastener 112 as shown in FIG. 7. The fixing member 21 has a second limiter portion; for example, the second limiter portion includes a top bead 2131 as shown in FIGS. 2, 3 and 6, and/or includes a second fastener 2113 as shown in FIG. 7. The first limiter portion is configured to cooperate with the second limiter portion to realize that the main machine assembly 10 and the fixing member 21 are positionally limited and are fixed in a situation where the main machine assembly 10 is fixed (detachably fixed) by being inserted into the fixing member 21. It should be noted that in order to make the structures such as grooves and through holes in FIG. 3 clear, only partial sectional structures of a part of components in FIG. 3 are shown.

For example, in such a situation that the first limiter portion includes a first groove 111 (FIG. 7 schematically shows a position of the first groove 111 by using a dotted circle) and the first fastener 112 and the second limiter portion includes the top bead 2131 and the second fastener 2113 that is configured to cooperate with the first fastener 112, the first fastener 112 is located at a lateral surface 11C (as shown in FIG. 7) of the first connector 11, and the lateral surface 11C intersects a surface (a first surface 111 as shown in FIG. 2) that is included by the first connector 11 and that faces the second connector 211. For example, the first fastener 112 and the second fastener 2113 may be one or two (as shown in FIG. 7) or more.

For example, in conjunction with FIGS. 2 and 6, the first surface 111 of the first connector 11 is attached to a second surface 2111 of the second connector 211 (these two surfaces are not labeled in FIG. 6). In other embodiments, for example, the first surface 111 and the second surface 2111 are unattached (for example, an orthographic projection of the first surface 111 on a plane where the second surface 2111 is located is outside the second surface 2111), as long as the first connector 11 and the second connector 2111 are configured to cooperate with each other.

In the embodiments of the present disclosure, for example, the second connector 211 is a rotator block (also referred to as a rotator); and for example, the rotator block is configured to be rotatable in a clockwise direction and in an anticlockwise direction indicated by arrows in FIG. 7 with a position of the top bead 2131 as a center of rotation, so that the insertion and extraction structure meets different usage requirements. In the case where the second connector 211 is the rotator block, for example, the fixing member 21 further includes a rotating fixing member 212 and a stir mechanism 213, the rotating fixing member 212 is configured to connect the second connector 211 and a body 23 of the support assembly 20, and the stir mechanism 213 is configured to prevent the first surface 111 of the first connector 11 from moving relative to the second surface 2111 of the second connector 211 in a direction in which the first surface 111 extends.

The insertion and extraction structure will be described in detail below by taking the second connector 211 as the rotator block (for convenience of understanding, the following description will be described by using “rotator block 211”).

In the embodiments of the present disclosure, for example, the support assembly 20 has a first recess 22 configured for accommodating the rotator block 211. The first recess 22 is located in the body 23 of the support assembly 20, and a first through hole 221 is in the first recess 22.

In the embodiments of the present disclosure, for example, the rotator block 211 has a second recess 2112 configured for accommodating the main machine assembly 10, and a second through hole 211B is in the second recess 2112.

In the embodiments of the present disclosure, for example, the rotating fixing member 212 has a first end 2121, a hollow portion 2122 and a second end 2123 which are sequentially connected; the first end 2121 is located in the second recess 2112, and the first end 2121 is provided with a third through hole 21211; the hollow portion 2122 is between the first through hole 221 and the second through hole 211B; the hollow portion 2122 has a cavity and communicates with the third through hole 21211; the second end 2123 is configured to be on the side of the support assembly 20 facing away from the first recess 22 in the situation where the main machine assembly 10 is fixed by being inserted into the fixing member 21 (as shown in FIG. 5 and FIG. 6); a size of an outer edge of the first end 2121 is larger than a diameter of the second through hole 211B, and a size of an outer end of the second end 2123 is smaller than the diameter of the second through hole 211B, so that the second end 2123 of the rotating fixing member is able to pass through the second through hole 211B and the first end 2121 is unable to pass through the second through hole 211B.

In the embodiments of the present disclosure, for example, in the situation where the main machine assembly 10 is fixed by being inserted into the fixing member 21, the stir mechanism 213 is located in the hollow portion 2122, and an end of the stir mechanism 213 passes through the third through hole 21211 and then connects the first limiter portion (see the first groove 1111 in FIG. 6). The stir mechanism 212 is configured to enter the third through hole 21211 under an action of an external force or is configured to bounce from the third through hole 21211 in the rotating fixing member 212.

In the embodiments of the present disclosure, for example, the second end 2123 of the rotating fixing member 212 has a recessed step structure; the fixing member 21 further includes a fastener structure 214 (for example, a circlip or other type of fastener structure); the fastener structure 214 is configured to be assembled with the recessed step structure of the second end 2123, so as to prevent the recessed step structure of the second end 2123 from passing through the first through hole 221 in the body 23 of the support assembly 20 and to allow the fixing member 21 to rotate with respect to the support assembly 20 under the action of the external force, in the situation where the main machine assembly 10 is inserted into the fixing member 10.

In the embodiments of the present disclosure, for example, the second limiter portion includes the top bead 2131, and the first limiter portion includes the first groove 1111 configured for accommodating the top bead 2131; the first groove 1111 is disposed at the first surface 111 (the surface that is included by the rotator block 211 and faces the main machine assembly 10).

In the embodiments of the present disclosure, for example, the stir mechanism 213 includes the top bead 2131, a spring 2132 and a screw 2133.

In the embodiments of the present disclosure, for example, referring to FIG. 5 and FIG. 6, FIG. 6 is an enlarged view of location A in FIG. 5, a first end 2131A of the top bead 2131 is connected with a first end 2132A of the spring 2132, and a second end 2131B of the top bead 2131 passes through the third through hole 21211 (as shown in FIG. 3) and then is connected with the first limiter portion (referring to the first groove 1111); the top bead 2131 is configured to enter the third through hole 21211 under the action of the external force or is configured to bounce from the third through hole 21211.

In the embodiments of the present disclosure, for example, the screw 2133 is provided with a second groove 2133C (as shown in FIG. 3) at a position where the screw 2133 contacts the second end 2132B of the spring 2132, and the second end 2132B of the spring 2132 is disposed in the second groove 2133C.

In the embodiments of the present disclosure, for example, the hollow portion 2122 has an internal thread that is configured to cooperate with an external thread of the screw 2133, and the screw 2133 is configured to fix the spring 2132 and the top bead 2131 in the hollow portion 2122.

In the embodiments of the present disclosure, in inserting the main machine assembly 10 into the support assembly 20, the main machine assembly 10 gives a lateral surface 2121C (as shown in FIG. 3) of the first end 2121 of the rotating fixing member 212 with a force which has a direction perpendicular to the lateral surface 2121C; at this time, the top bead 2131 is subjected to the force, moves toward the spring 2132 and moves into the hollow portion 2122 under the action of the force; after insertion of the main machine assembly 10 into the support assembly 20 is completed, because the main machine assembly 10 has the first groove 1111 configured to cooperate with the top bead 2131, the top bead 2131 bounces from the third through hole 21211 along a direction from the spring 2132 to the top bead 2131 under an action of the spring 2132 and then is inserted into the first groove 1111, so as to reach an limiting function of the rotator block 211 and the first connector 11.

In the embodiments of the present disclosure, for example, referring to FIG. 7, the second fastener 2113 included by the second limiter portion is, for example, a protruding fastening point, and the protruding fastening point is disposed at the second connector (e.g., the rotator block) 211, and the first fastener 112 included by the first limiter portion is, for example, a fastening groove configured for accommodating the fastening point. Alternatively, in other embodiments, the first fastener 112 included by the first limiter portion is, for example, the protruding fastening point, the protruding fastening point is disposed at the first connector 11, and the second fastener 2113 included by the second limiter portion is, for example, the fastening groove that is configured for accommodating the fastening point.

In the embodiments of the present disclosure, in inserting the first connector 11 into the second connector 211, the fastening point is stuck in the fastening groove in presence of the force being greater than a certain value. In FIG. 7, an assembly view of inside of the insertion and extraction structure is shown, which is not a view of a surface of the insertion and extraction structure.

In the embodiments of the present disclosure, for example, the first fastener 112 included by the first limiter portion is a sliding groove, and the second fastener 2113 included by the second limiter portion is a sliding rail that is configured to cooperate with the sliding groove; or the first fastener 112 included by the first limiter portion is the sliding rail, and the second fastener 2113 included by the second limiter portion is the sliding groove that is configured to cooperate with the sliding rail. The second limiter portion is disposed at the second connector 211.

In the embodiments of the present disclosure, the assembly between the guiding groove and the sliding rail prevents the first connector and the second connector from being separated with each other in a direction perpendicular to the first surface.

In the above embodiments, one of the first fastener 112 and the second fastener 2113 is the protruding fastening point and the other is the fastening groove configured for accommodating the fastening point; or, one of the first fastener 112 and the second fastener 2113 is the sliding groove and the other is the sliding rail that is configured to cooperate with the sliding groove. Implementations of the first fastener 112 and the second fastener 2113 in the embodiments of the present disclosure include, but are not limited to, those listed manners.

In the embodiments of the present disclosure, for example, the insertion and extraction structure is assembled in the following steps: in a first step, the top bead 2131 is placed in the hollow portion 2122 of the rotating fixing member 212, then the spring 2132 is placed in the hollow portion 2122, then the screw 2133 is placed in the hollow portion, and the spring and the top bead are locked firmly; in a second step, the rotator block 211 is mounted in the first recess 22 of the support assembly 20, the rotating fixing member 212 obtained in the first step is inserted into the support assembly 20 from the second through hole 211B of the rotator block 211 until the rotating fixing member 212 passes through the first through hole 221, so that the first end 2121 of the rotating fixing member 212 is fixed in the second recess 2112 of the rotator block 211, and then the fastener structure 214 is stuck into a groove (namely the above recessed step structure) at an outer side of the second end 2123 of the rotating fixing member 212 to allow the second end 2123 of the rotating fixing member 212 to be fixed at the side of the support assembly 20 away from the first recess 22, so as to complete the assembly of the support assembly 20; then, the first connector 11 of the main machine assembly 10 is inserted into the rotator block 211 along the first surface 2111 of the rotator block 211 to complete the assembly between the main machine assembly 10 and the support assembly 20.

The embodiments of the present disclosure further provide an eyewear, such as a VR (Virtual Reality) eyewear, and the eyewear includes an eyewear leg, an optomechanical assembly, and the insertion and extraction structure according to any one of the above embodiments; the eyewear leg is connected with the support assembly 20, and the optomechanical assembly is connected with the main machine assembly 10.

The embodiments of the present disclosure further provide an electronic device including the insertion and extraction structure provided by any one of the above embodiments. For example, the electronic device is the eyewear or a watch or any other type of electronic product.

In summary, the insertion and extraction structure, the eyewear and the electronic device provided by the embodiments of the present disclosure include the main machine assembly and the support assembly, and the support assembly includes the fixing member; the main machine assembly is provided with the first connector, the fixing member is provided the second connector, the main machine assembly is configured to be inserted into or be extracted from the fixing member by the cooperation between the first connector and the second connector; the first connector is provided with the first limiter portion, the fixing member is provided with the second limiter portion, and the first limiter portion is configured to cooperate with the second limiter portion so that the main machine assembly and the fixing member are positionally limited and are fixed in the situation where the main machine assembly is fixed by being inserted into the fixing member. The embodiments of the present disclosure realizes the insertion and extraction of the main machine assembly with respect to the support assembly, and fixes the main machine assembly and the support assembly together during the insertion.

What are described above is related to the illustrative embodiments of the disclosure only and not limitative to the scope of the disclosure; the scopes of the disclosure are defined by the accompanying claims.

What is claimed is:

1. An insertion and extraction structure, comprising a main machine assembly and a support assembly, wherein
the support assembly comprises a fixing member;
the main machine assembly comprises a first connector, the fixing member comprises a second connector, and the main machine assembly is configured to be inserted into or be extracted from the fixing member by cooperation of the first connector and the second connector; the first connector comprises a first limiter portion, the fixing member comprises a second limiter portion, the first limiter portion is configured to cooperate with the second limiter portion to achieve that the main machine assembly and the fixing member are positionally limited and are fixed in a situation where the main machine assembly is fixed by being inserted into the fixing member.

2. The insertion and extraction structure according to claim 1, wherein a first surface of the first connector is attached to a second surface of the second connector.

3. The insertion and extraction structure according to claim 2, wherein the second connector is a rotator block, and the fixing member further comprises a rotating fixing member and a stir mechanism;
the support assembly is provided with a first recess configured for accommodating the rotator block, and the first recess is provided with a first through hole;
the rotator block is provided with a second recess configured for accommodating the main machine assembly, and the second recess is provided with a second through hole;
the rotating fixing member comprises a first end, a hollow portion and a second end which are sequentially connected, the first end is in the second recess and is provided with a third through hole, the hollow portion is between the first through hole and the second through hole, the hollow portion has a cavity and communicates with the third through hole, and the second end is configured to be on a side of the support assembly away from the first recess in the situation where the main machine assembly is fixed by being inserted into the fixing member; a size of an outer edge of the first end is larger than a diameter of the second through hole;
the stir mechanism is in the hollow portion, an end of the stir mechanism is provided with the second limiter portion, the second limiter portion is configured to penetrate the third through hole, and the second limiter portion is configured to enter the third through hole under an action of an external force or is configured to bounce from the third through hole.

4. The insertion and extraction structure according to claim 3, wherein
the second end comprises a recessed step structure; the fixing member further comprises a fastener structure; the fastener structure is configured to be assembled with the recessed step structure to avoid the recessed step structure from passing through the first through hole and to allow the fixing member to rotate relative to the support assembly under the action of the external force in the situation where the main machine assembly is fixed by being inserted into the fixing member.

5. The insertion and extraction structure according to claim 4, wherein the second limiter portion comprises a top bead, the first limiter portion comprises a first groove configured for accommodating the top bead; the first groove is at the first surface.

6. The insertion and extraction structure according to claim 5, wherein
the stir mechanism comprises the top bead, a spring and a screw;
a first end of the top bead is connected with a first end of the spring, and a second end of the top bead is configured to pass through the third through hole and then connect the second limiter portion;
the top bead is configured to enter the third through hole along a direction from the top bead to the screw under the external force or is configured to bounce from the third through hole along a direction from the screw to the top bead under an action of the spring;
the screw is provided with a second groove at a position where the screw contacts a second end of the spring, and the second end of the spring is in the second groove;
the hollow portion comprises an internal thread that is configured to cooperate with an external thread of the screw, and the screw is configured to fix the spring and the top bead in the hollow portion.

7. The insertion and extraction structure according to claim 1, wherein the second connector is a rotator block, and the fixing member further comprises a rotating fixing member and a stir mechanism;
the support assembly is provided with a first recess configured for accommodating the rotator block, and the first recess is provided with a first through hole;
the rotator block is provided with a second recess configured for accommodating the main machine assembly, and the second recess is provided with a second through hole;
the rotating fixing member comprises a first end, a hollow portion and a second end which are sequentially connected, the first end is in the second recess and is provided with a third through hole, the hollow portion is between the first through hole and the second through hole, the hollow portion has a cavity and communicates with the third through hole, and the second end is configured to be on a side of the support assembly away from the first recess in the situation where the main machine assembly is fixed by being inserted into the fixing member; a size of an outer edge of the first end is larger than a diameter of the second through hole;
the stir mechanism is in the hollow portion, an end of the stir mechanism is provided with the second limiter portion, the second limiter portion is configured to penetrate the third through hole, and the second limiter portion is configured to enter the third through hole under an action of an external force or is configured to bounce from the third through hole.

8. The insertion and extraction structure according to claim 7, wherein
the second end comprises a recessed step structure; the fixing member further comprises a fastener structure; the fastener structure is configured to be assembled with the recessed step structure to avoid the recessed step structure from passing through the first through hole and to allow the fixing member to rotate relative to the support assembly under the action of the external force in the situation where the main machine assembly is fixed by being inserted into the fixing member.

9. The insertion and extraction structure according to claim 8, wherein the second limiter portion comprises a top bead, and the first limiter portion comprises a first groove configured for accommodating the top bead; the first groove is at a surface, which is comprised by the first connector and faces the second connector.

10. The insertion and extraction structure according to claim 9, wherein
the stir mechanism comprises the top bead, a spring and a screw;
a first end of the top bead is connected with a first end of the spring, and a second end of the top bead is configured to pass through the third through hole and then connect the second limiter portion;
the top bead is configured to enter the third through hole along a direction from the top bead to the screw under the external force or is configured to bounce from the third through hole along a direction from the screw to the top bead under an action of the spring;
the screw is provided with a second groove at a position where the screw contacts a second end of the spring, and the second end of the spring is in the second groove;
the hollow portion comprises an internal thread that is configured to cooperate with an external thread of the screw, and the screw is configured to fix the spring and the top bead in the hollow portion.

11. The insertion and extraction structure according to claim 7, wherein the second limiter portion comprises a top bead, the first limiter portion comprises a first groove configured for accommodating the top bead; the first groove is at a surface which is comprised by the first connector and faces the second connector.

12. The insertion and extraction structure according to claim 11, wherein
the stir mechanism comprises the top bead, a spring and a screw;
a first end of the top bead is connected with a first end of the spring, and a second end of the top bead is configured to pass through the third through hole and then connect the second limiter portion;
the top bead is configured to enter the third through hole along a direction from the top bead to the screw under the external force or is configured to bounce from the third through hole along a direction from the screw to the top bead under an action of the spring;
the screw is provided with a second groove at a position where the screw contacts a second end of the spring, and the second end of the spring is in the second groove;
the hollow portion comprises an internal thread that is configured to cooperate with an external thread of the screw, and the screw is configured to fix the spring and the top bead in the hollow portion.

13. The insertion and extraction structure according to claim 11, wherein
the first limiter portion further comprises a first fastener, and the second limiter portion further comprises a second fastener that is configured to cooperate with the first fastener.

14. The insertion and extraction structure according to claim 13, wherein the first fastener of the first limiter portion is at a lateral surface of the first connector, and the lateral surface intersects the surface that is comprised by the first connector and faces the second connector.

15. The insertion and extraction structure according to claim 13, wherein
one of the first fastener and the second fastener is a protruding fastening point and the other of the first fastener and the second fastener is a fastening groove configured for accommodating the fastening point; or
one of the first fastener and the second fastener is a sliding groove and the other of the first fastener and the second fastener is a sliding rail that is configured to cooperate with the sliding groove.

16. The insertion and extraction structure according to claim 1, wherein
the second limiter portion comprises a protruding fastening point, the second connector is provided with the protruding fastening point, and the first limiter portion comprises a fastening groove configured for receiving the fastening point; or
the first limiter portion comprises a protruding fastening point, and the second limiter portion comprises a fastening groove configured for receiving the fastening point, and the second connector is provided with the fastening groove.

17. The insertion and extraction structure according to claim 1, wherein the first limiter portion comprises a sliding groove, and the second limiter portion comprises a sliding rail that is configured to cooperate with the sliding groove; or the first limiter portion comprises the sliding rail, and the second limiter portion comprises the sliding groove that is configured to cooperate with the slide rail.

18. An eyewear, comprising an eyewear leg, an optomechanical assembly and the insertion and extraction structure according to claim 1, wherein the eyewear leg is connected with the support assembly, and the optomechanical assembly is connected with the main machine assembly.

19. An electronic device, comprising the insertion and extraction structure according to claim 1.
